(19) United States
(12) Patent Application Publication
(10) Pub. No.: US 2013/0130597 A1
(43) Pub. Date: May 23, 2013

(54) GLASS TREATMENT APPARATUS AND METHODS OF TREATING GLASS

(71) Applicants: James William Brown, Painted Post, NY (US); Keith Mitchell Hill, Horseheads, NY (US); Siva Venkatachalam, Painted Post, NY (US); Edward Zhmayev, Ithaca, NY (US); Naiyue Zhou, Painted Post, NY (US)

(72) Inventors: James William Brown, Painted Post, NY (US); Keith Mitchell Hill, Horseheads, NY (US); Siva Venkatachalam, Painted Post, NY (US); Edward Zhmayev, Ithaca, NY (US); Naiyue Zhou, Painted Post, NY (US)

(21) Appl. No.: 13/300,921

(22) Filed: Nov. 21, 2011

(51) Int. Cl. B24B 1/00; B08B 3/02; B24B 55/12; B24B 9/10; B24B 53/00

(52) U.S. Cl. 451/44; 451/73; 451/178; 451/444; 451/54; 451/56; 134/151

(57) ABSTRACT

A glass treatment apparatus, in one example, can include a fluid dispensing device configured to dispense a substantially laminar flow of a fluid film. In another example, a shroud substantially circumscribes an outer peripheral surface of a working wheel. The shroud includes a slot configured to receive an edge portion of a glass sheet. Methods of treating glass, in one example, include the step of dispensing a substantially laminar flow of a fluid film along a fluid plane to subsequently land on a first side of a glass sheet. In further examples, a fluid is passed over an inner surface of a shroud to carry away machined particles from a glass sheet. In still further examples, an outer peripheral surface of a working wheel is impacted with a fluid stream to clean the working wheel from glass particles generated when machining an edge of the glass sheet.

### TECHNICAL FIELD

The disclosure relates generally to a glass treatment apparatus and methods and, more particularly, to glass treatment apparatus and methods for machining a surface of a glass sheet while maintaining the pristine surfaces of the glass sheet.

### BACKGROUND

It is known to fusion draw glass ribbon from a fusion draw machine. The ribbon is typically further processed into glass sheets that may be used to generate various liquid crystal display configurations. During processing, it is often desired to finish the edges of the glass sheet or glass ribbon to remove sharp edges and/or other defects. There is a need to carry out such finishing techniques while maintaining the pristine surfaces of the glass sheet. Sheet edge finishing is critical to improve the edge profile and strength required for handling and the customer's panel making process.

### SUMMARY

The following presents a simplified summary of the disclosure in order to provide a basic understanding of some example aspects described in the detailed description.

In one example aspect of the disclosure, a glass treatment apparatus comprises a fluid dispensing device including first and second flow expanders and a dispensing surface facing a dispensing direction. The dispensing surface defines an elongated opening including an elongated central portion extending between first and second opposed end portions. The first opposed end portion is provided with the first flow expander extending from the dispensing surface in the dispensing direction and the second opposed end portion is provided with the second flow expander extending from the dispensing surface in the dispensing direction. The fluid dispensing device is configured to dispense a substantially laminar flow of a fluid film from the elongated opening in the dispensing direction between the first and second flow expanders to form a water film with certain thickness and velocity such that glass particles generated from edge finishing will be carried away by the water film before the glass particles can penetrate through the water film and contact the sheet surface.

In another example aspect of the disclosure, a glass treatment apparatus comprises a fluid dispensing device including a dispensing surface facing a dispensing direction. The dispensing surface defines an elongated opening. The fluid dispensing device further includes a first elongated chamber in fluid communication with the elongated opening and including a first chamber axis extending substantially parallel to the elongated opening. The fluid dispensing device further includes a second chamber in fluid communication with the first elongated chamber. The fluid dispensing device is configured to dispense a substantially laminar flow of a fluid film from the elongated opening in the dispensing direction.

In yet another example aspect of the disclosure, a glass treatment apparatus further comprises a working wheel configured to rotate such that an outer peripheral surface of the working wheel machines a surface of a glass sheet. The glass treatment apparatus also includes a shroud substantially circumscribing the outer peripheral surface of the working wheel to prevent flying particles produced during edge finishing from contacting the sheet surface. The shroud includes a slot configured to receive an edge portion of the glass sheet.

In still another example aspect of the disclosure, a method of treating glass comprises the steps of dispensing a substantially laminar flow of a fluid film along a fluid plane to subsequently land on a first side of a glass sheet and machining an edge of the glass sheet, wherein machined particles of glass are entrained in the fluid film and carried away from the glass sheet.

In accordance with a further aspect of the disclosure, a method of treating glass comprises the steps of providing: a glass sheet; a working wheel with an outer peripheral surface; and a shroud substantially circumscribing the outer peripheral surface, wherein the shroud includes a slot. The method further includes the steps of rotating the working wheel about a rotation axis and moving a glass sheet and the working wheel relative to each other such that an edge portion of the glass sheet passes through the slot with an edge of the glass sheet being machined by the rotating working wheel. The method still further includes the step of passing a fluid over an inner surface of the shroud to carry away machined particles from the glass sheet generated when machining the edge of the glass sheet.

In accordance another aspect of the disclosure, a method of treating glass comprises the steps of providing: a glass sheet; a working wheel with an outer peripheral surface; and a shroud substantially circumscribing the outer peripheral surface, wherein the shroud includes a slot. The method further includes the steps of rotating the working wheel about a rotation axis and moving a glass sheet and the working wheel relative to each other such that an edge portion of the glass sheet passes through the slot with an edge of the glass sheet being machined by the rotating working wheel. The method further includes the step of impacting the outer peripheral surface of the working wheel with a fluid stream to clean from the working wheel glass particles generated when machining the edge of the glass sheet such that glass particles will not get reintroduced into the glass edge to negatively affect the grinding process.

### BRIEF DESCRIPTION OF THE DRAWINGS

These and other aspects are better understood when the following detailed description is read with reference to the accompanying drawings, in which:

FIG. 1 is a perspective view of a glass treatment apparatus in accordance with one example of the disclosure;

FIG. 2 is a top view of an example fluid dispensing device of the glass treatment apparatus of FIG. 1;

FIG. 3 is an end view of the fluid dispensing device along line 3-3 of FIG. 2;

FIG. 4 is a cross sectional view of the fluid dispensing device along line 4-4 of FIG. 2;

FIG. 5 is an enlarged view of portions of the fluid dispensing device of FIG. 4;

FIG. 6 is a front view of the fluid dispensing device along line 6-6 of FIG. 2;

FIG. 7 is a cross sectional view of the fluid dispensing device along line 7-7 of FIG. 2;

FIG. 8 is a top view of the fluid dispensing apparatus of FIG. 1;

FIG. 9 is a front view of the fluid dispensing apparatus of FIG. 1;

FIG. 10 is a bottom view of the fluid dispensing apparatus of FIG. 1;

FIG. 11 is a perspective view of another fluid dispensing device of the glass treatment apparatus of FIG. 1;

FIG. 12 is a cross sectional view of the fluid dispensing device along line 12-12 of FIG. 11;

FIG. 13 is a cross sectional view of the fluid dispensing device along line 13-13 of FIG. 11;

FIG. 14 is a front view of an example shroud of the glass treatment device of FIG. 1;

FIG. 15 is a lower perspective view of the shroud of FIG. 14; and

FIG. 16 is another lower perspective view of the shroud of FIG. 14.

### DETAILED DESCRIPTION

Examples will now be described more fully hereinafter with reference to the accompanying drawings in which example embodiments are shown. Whenever possible, the same reference numerals are used throughout the drawings to refer to the same or like parts. However, aspects may be embodied in many different forms and should not be construed as limited to the embodiments set forth herein.

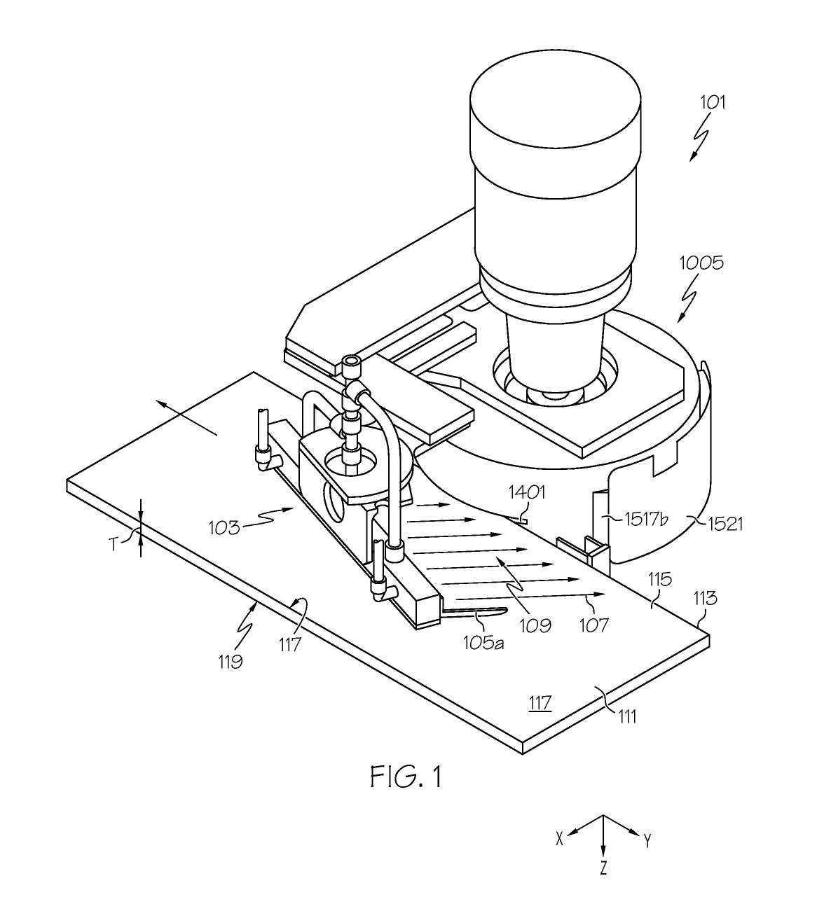

Referring now to FIG. 1, an example glass treatment apparatus 101 is provided with various example features that may be used either alone or in combination to help prevent particles from contaminating the pristine surfaces of the glass sheet. In one example, the glass sheet can comprise a sheet of glass that may be incorporated in a liquid crystal display wherein there is a desire to machine a surface of the edge portion 115 of the glass sheet 111 to improve the edge quality of the glass sheet. As shown, the surface can comprise the outer peripheral edge 113 of the glass sheet 111 between the thickness “T” of the glass sheet 111 from a first surface 117 and a second surface 119 of the glass sheet 111. In addition or alternatively, the glass treatment apparatus 101 may be designed to machine a surface of the edge portion comprising the first surface 117 and/or the second surface 119 without machining the outer peripheral edge 113 of the glass sheet 111. In further examples, one or both of the first surface 117 and/or the second surface 119 may be machined together with the outer peripheral edge 113 of the glass sheet 111. For example, the glass treatment apparatus 101 may be designed to provide an angled or rounded transition between the first surface 117 and/or the second surface 119 and the outer peripheral edge 113. Machining of the surface of the edge portion 115 of the glass sheet 111 can reduce the probability of stress fractures from forming and propagating to the interior portion of the glass sheet and/or may otherwise enhance the quality of the glass sheet 111.

Although not required, as shown in FIG. 1, the illustrated example the glass treatment apparatus 101 is shown machining a glass sheet 111 that is in a substantially horizontal orientation wherein the glass sheet 111 extends substantially along the illustrated X-Y plane with the force of gravity acting in the Z direction. In further example, the glass sheet may be oriented at an incline relative to the X-Y orientation and, in some examples, may be oriented along the X-Z and/or Y-Z plane. Regardless of the orientation, one of many fluid dispensing devices may be used to dispense a substantially laminar flow of a fluid film along the first surface 117 and/or the second surface 119 of the glass sheet to help prevent particles from contaminating the pristine surfaces 117, 119 of the glass sheet 111.

A substantially laminar flow of fluid film may include small portions that are not in laminar flow but includes a substantial portion of the flow in laminar flow. For instance, a substantially laminar flow can include one or more relatively small areas of the fluid film may include eddies or other flow disturbances while the remaining portions of the fluid film are in a substantially laminar flow. Providing a fluid film in laminar flow can be used to overcome the particle sources and particle dynamics typically observed during the machining process. Indeed, the fluid film can provide a protective fluid barrier for the first surface 117 and or the second surface 119 from particles generated during the machining process.

In a horizontal orientation, it is possible to provide one or both of the first surface 117 and/or second surface 119 with one or more fluid dispensing devices. For example, as shown in FIG. 1, the glass treatment apparatus 101 may include a fluid dispensing device 103 that may be used to generate a laminar flow 107 of a fluid film 109 coat the first surface 117, that may comprise the upper surface of the glass sheet in the orientation shown in FIG. 1. The fluid film may be dispensed as a planar sheet of fluid film 109 designed to coat the first surface 117 of the glass sheet 111.

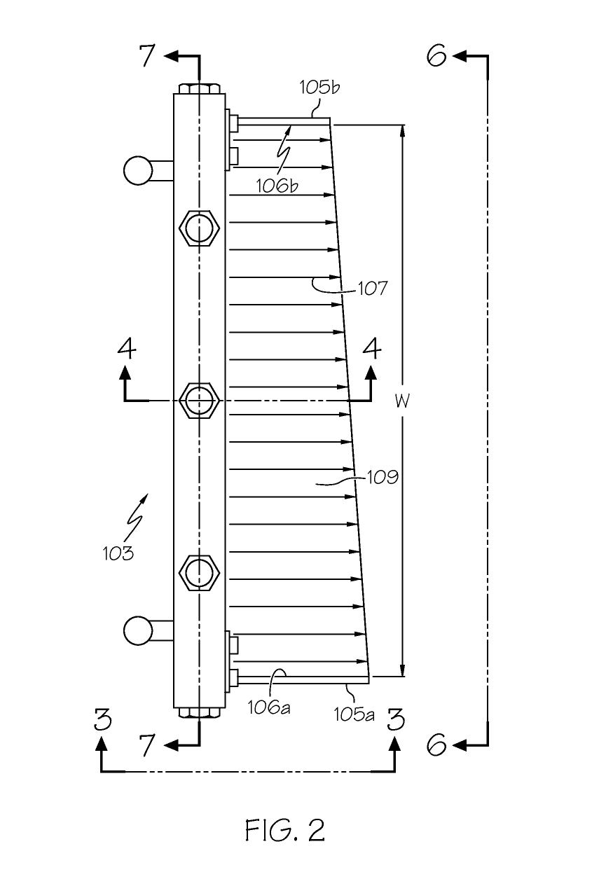

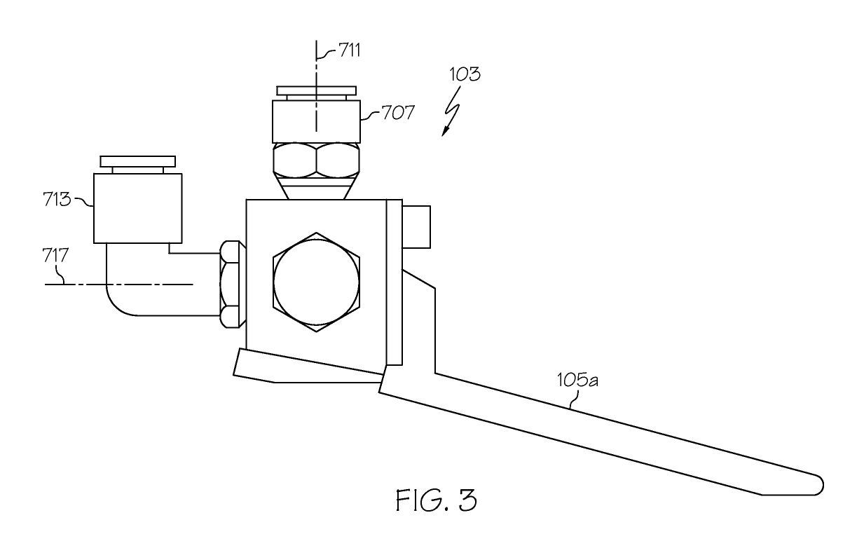

FIGS. 2-8 illustrate example features of one fluid dispensing device 103 that may be optionally used to protect the first surface 117 of the glass sheet 111 although a similar or identical construction may be used to protect the second surface 119 of the glass sheet in further examples. FIG. 2 illustrates a top view of the fluid dispensing device 103 with a fluid film 109 being dispensed for illustration purposes. As shown, the fluid film 109 can have a width “W” transverse to the laminar flow 107 that extends between a first flow expander 105a and a second flow expander 105b. As shown, the first and second flow expanders 105a, 105b can each include a corresponding expanding surface 106a, 106b that face one another. As shown, the expanding surfaces 106a, 106b can be substantially planar and may also extend substantially parallel to one another. With such a configuration, the flow expanders 105a, 105b can help maintain the fluid film 109 with a substantially constant width “W” as the fluid film is deposited to coat the first surface 117 of the glass sheet 111. Although not shown, the expanding surfaces 106a, 106b may converge or diverge from one another in further examples to control the final width of the fluid film 109 being deposited on the first surface of the glass sheet 111.

The flow expanders 105a, 105b, if provided, can operate to expand the width of the fluid film 109 that is being deposited to coat the first surface 117. Indeed, without flow expanders, the surface tension of the fluid, such as water, would naturally tend to cause a converging flow of the fluid film 109 as the fluid film travels away from the elongated opening of the fluid dispensing device 103. By contacting the outer edges of the fluid film 109 with the expanding surfaces 106a, 106b, the fluid film is expanded from the natural tendency of the fluid film to converge as it travels away from the elongated opening. If the fluid film were allowed to converge uncontrolled, a substantially turbulent flow may eventually be produced when introducing the fluid film to coat the surface 117 of the glass sheet. As such, the flow expanders 105a, 105b may be provided to help maintain the laminar flow 107 of the fluid film 109 as it is placed on the surface 117 of the glass sheet.

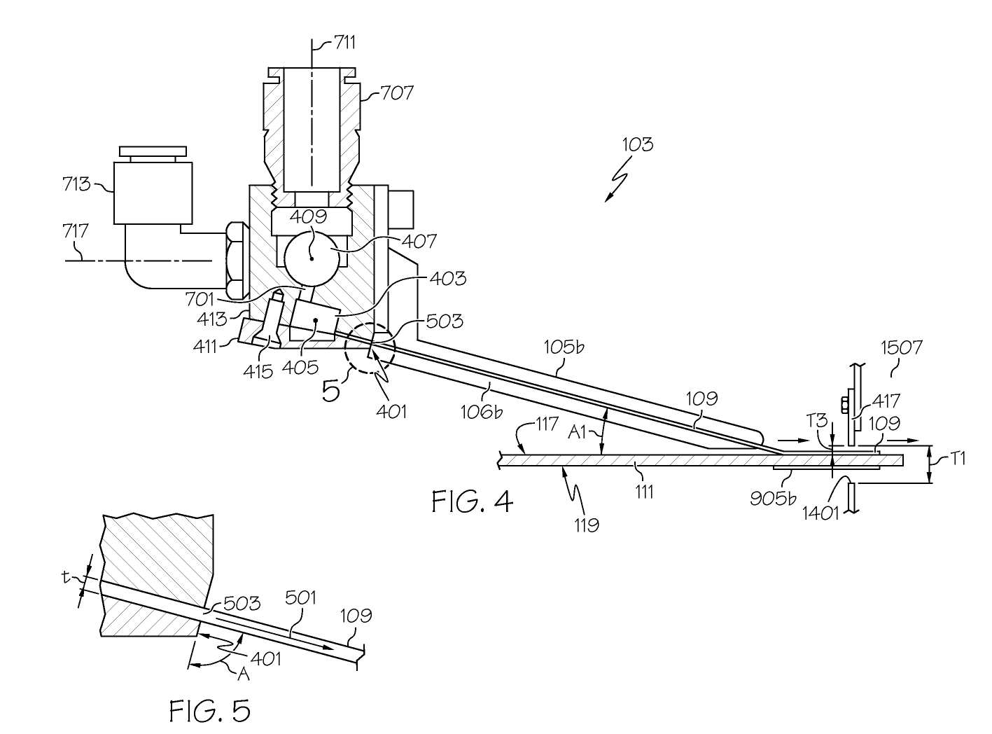

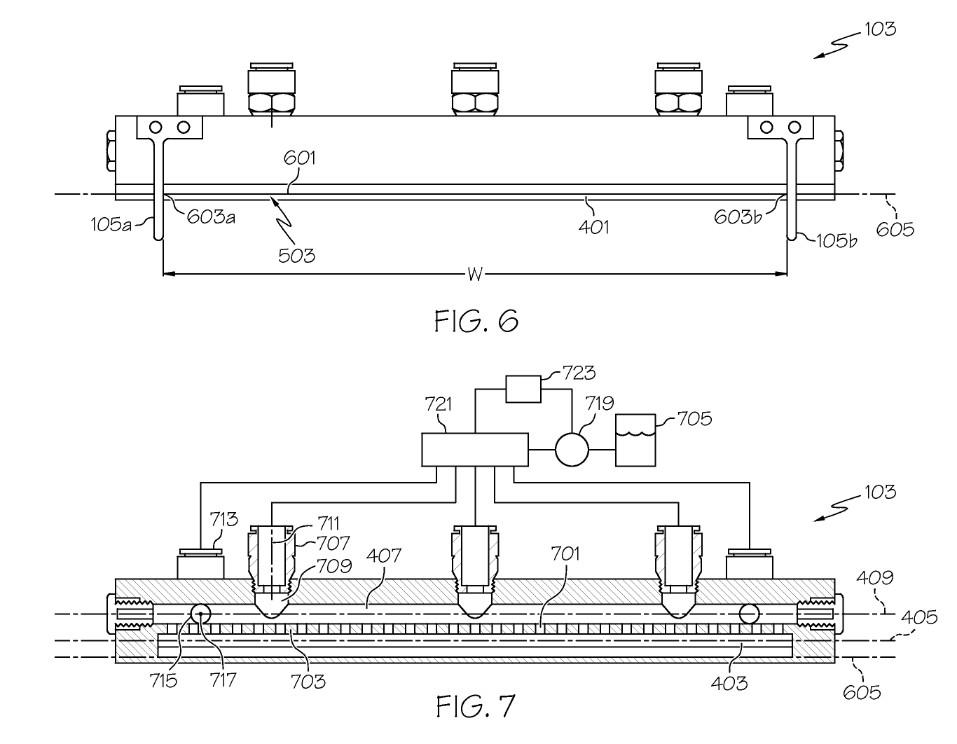

As shown in FIGS. 2-4, the first and second flow expander 105a, 105b may be substantially identical or similar to one another. In the illustrated example, the first flow expander 105a may be longer than the second flow expander 105b although the flow expanders may have substantially identical lengths in further examples. As further shown in FIGS. 4 and 5, the fluid dispensing device 103 includes a dispensing surface 401 facing a dispensing direction 501. As shown in FIG. 6, the first dispensing surface 401 defines an elongated opening 503 that is elongated to define the width “W” of the fluid film 109. Although not necessarily to scale, as shown in FIG. 5, the elongated opening 503 can include a thickness “t” within a range of from about 50 microns to about 1 mm, for example, from about 100 microns to about 500 microns, for example, from about 200 microns to about 300 microns, for example, about 250 microns.

As further shown in FIG. 5, in one example, the fluid dispensing device 103 can be configured to dispense the laminar fluid film 109 such that the dispensing direction 501 at an angle “A” that can be substantially 90° relative to the dispensing surface 401. Providing the dispensing direction 501 of the fluid film 109 in a substantially perpendicular orientation with respect to the dispensing surface 401 can help prevent the fluid film 109 exiting from the elongated opening 503 from wrapping backwards and thereby creating a turbulent flow. As such, dispensing the laminar fluid film 109 such that the dispensing direction at an angle “A” that is substantially perpendicular to the dispensing surface 401 can help maintain the laminar flow 107 of the fluid film 109.

As shown in FIG. 6, the dispensing surface 401 defines the elongated opening 503 with an elongated central portion 601 extending along an elongated axis 605 between first and second opposed end portions 603a, 603b. The first opposed end portion 603a can be provided with the first flow expander 105a extending from the dispensing surface 401 in the dispensing direction 501 and the second opposed end portion 603b can be provided with the second flow expander 105b extending from the dispensing surface 401 in the dispensing direction 501. As previously discussed, the width “W” of the fluid film 109 can thereby be defined by the elongated opening 503 with the optional flow expanders 105a, 105b.

Various structures may be designed to deliver fluid, such as water, through the elongated opening 503 to achieve the fluid film 109 in laminar flow 107. For example, the fluid dispensing device 103 can include a first elongated chamber 403 having a first chamber axis 405 extending along an elongated axis 605 of the elongated opening 503, wherein the first elongated chamber 403 is in fluid communication with the elongated opening 503. The first elongated chamber 403, if provided, may be formed by a single portion or defined by a plurality of portions fastened together. For example, as shown in FIG. 4, the first elongated chamber 403 may be formed by fastening a second portion 411 to a first portion 413 with fasteners 415. In further examples, the fluid dispensing device 103 can include an optional second elongated chamber 407 including a second chamber axis 409 substantially parallel to the first chamber axis 405. In such examples, the second elongated chamber 407 can be placed in fluid communication with the first elongated chamber 403 and the first elongated chamber 403 can be positioned along a flow path between the elongated opening 503 and the second elongated chamber 407. As such, the first elongated chamber 403 can be positioned downstream from the second elongated chamber 407 and the elongated opening 503 can be positioned downstream from the first and second elongated chambers 403, 407. In one example, as shown in FIG. 6, fluid communication between the first and second elongated chambers 403, 407 may be provided by a plurality of apertures 701 extending through an elongated partition wall 703 extending between the elongated chambers.

As shown, the first chamber axis 405 can be oriented substantially parallel to the elongated opening 503 and the second chamber axis 409 can extend substantially parallel to the first chamber axis 405 and the elongated opening 503. Providing the second elongated chamber 407 along the first elongated chamber 405 can further facilitate control pressure distribution and fluid flow along the length of the elongated opening 503, thereby further helping provide an even flow that facilitates maintenance of an even and laminar flow 107 of fluid film 109 through the elongated opening 503.

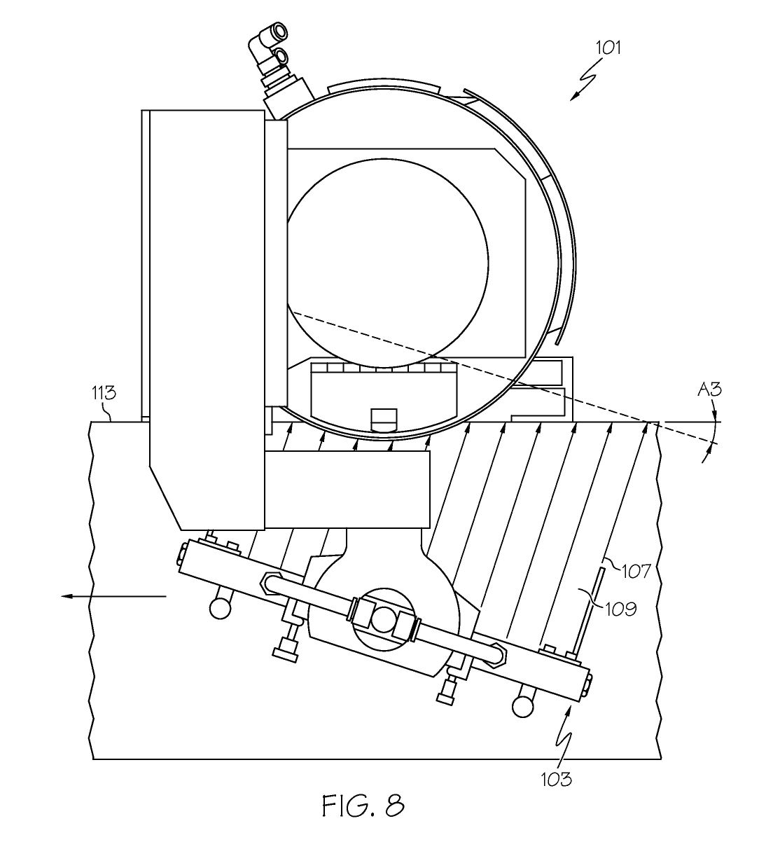

As shown in FIG. 7, a fluid source 705, such as a container of water, may be placed in fluid communication with one or more first ports 707 configured to introduce fluid through an opening 709 into the second elongated chamber 407 along an axis 711 that may be perpendicular to the second chamber axis 409. In addition or alternatively, the fluid source 705 may be placed in fluid communication with one or more second ports 713 configured to introduce fluid through an opening 715 into the second elongated chamber 407 along an axis 717 that may also be perpendicular to the second chamber axis 409 and/or each elongated axis 711 of the first fluid port 707. Providing multiple entry points for the fluid can help facilitate maintenance of an even and laminar flow 107 of fluid film 109 through the elongated opening 503. In one example, a pump 719 may provide fluid to a manifold 721 that may distribute the fluid to the first and second ports 707, 713 in a manner that best achieves uniform laminar flow in the fluid film. A computer 723 may control fluid flow through the ports by operating valves in the manifold and/or controlling operation of the pump 719.

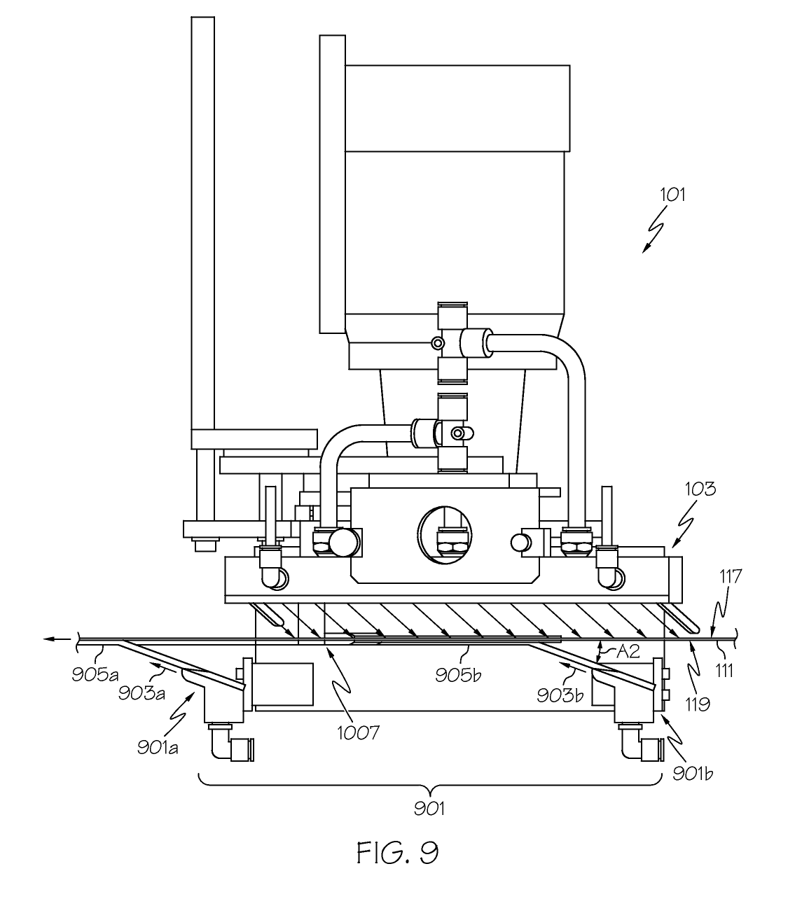

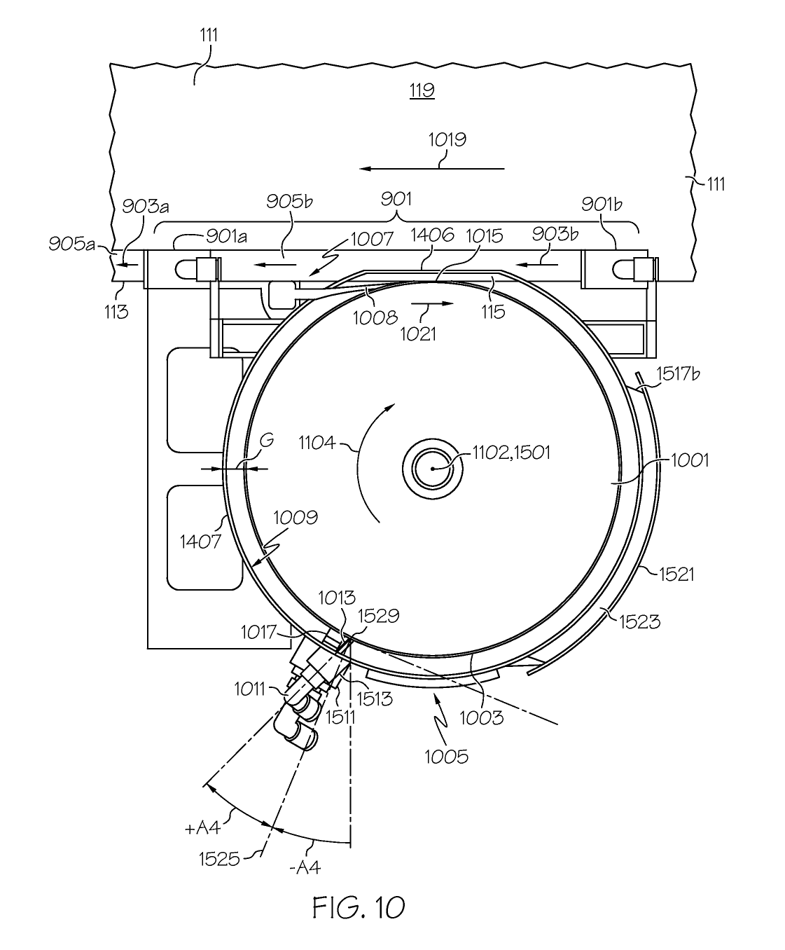

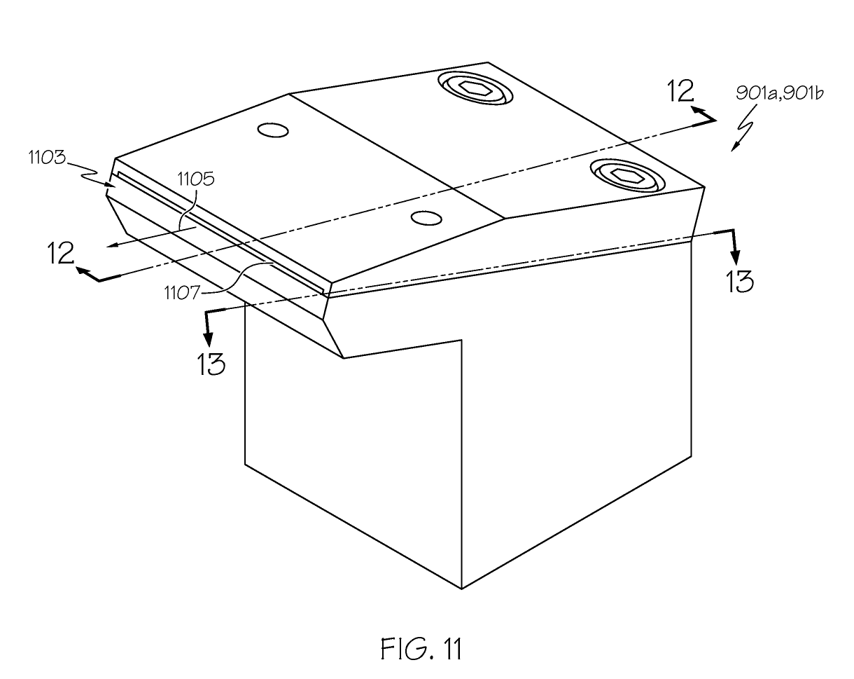

FIGS. 9-13 disclose another example fluid dispensing device 901 of the glass treatment apparatus 101. As shown in FIGS. 9 and 10, the fluid dispensing device can include a first dispensing device 901a and a second dispensing device 901b although a single dispensing device or more than two dispensing devices may be used in further examples. Moreover, as shown, the fluid dispensing devices 901a, 901b may be identical to one another although alternative constructions may be provided in further examples. The fluid dispensing devices 901a, 901b can be configured to dispense a substantially laminar flow 903a, 903b of a fluid film 905a, 905b from an elongated opening in a dispensing direction of the fluid dispensing device.

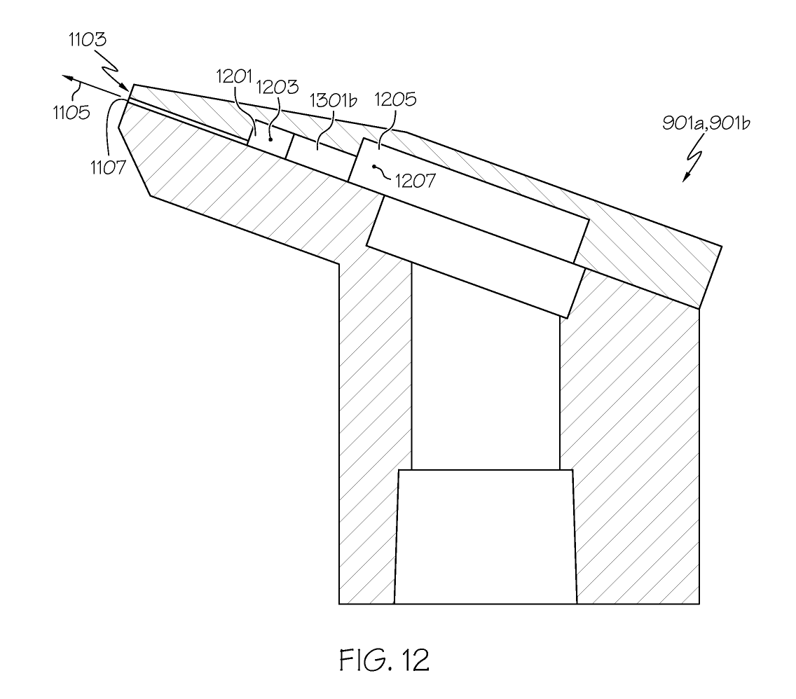

The fluid dispensing devices 901a, 901b can be designed to coat the second surface 119 with the substantially laminar flow 903a, 903b of the fluid film 905a, 905b. In the illustrated orientation, the second surface 119 can comprise the lower surface of the glass sheet 111. As such, the fluid dispensing devices 901a, 901b may provide a relatively reduce width fluid film when compared to the fluid film 109 associated with the fluid dispensing device 103 discussed above. As such, the flow expanders may not be necessary for the fluid dispensing devices illustrated in FIGS. 11 and 12.

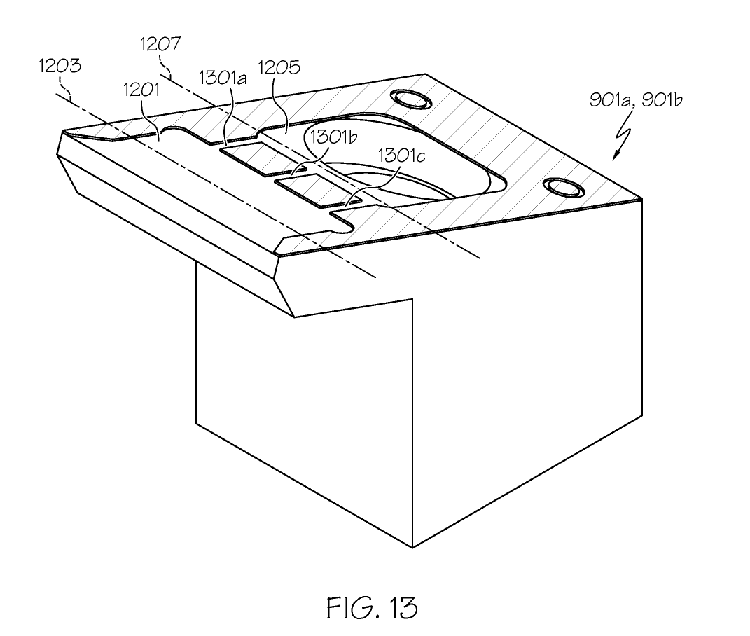

As shown in FIGS. 11 and 12, the fluid dispensing devices 901a, 901b can include a dispensing surface 1103 facing a dispensing direction 1105, wherein the dispensing surface 1103 defines an elongated opening 1107. As shown in FIG. 12, the fluid dispensing devices 901a, 901b each further includes a first elongated chamber 1201 in fluid communication with the elongated opening 1107. The first elongated chamber 1201 can include a first chamber axis 1203 extending substantially parallel to the elongated opening 1107. In another example, the fluid dispensing devices 901a, 901b each further includes a second chamber 1205 in fluid communication with the first elongated chamber 1201. Although not necessary, as shown, the second chamber 1205 may be elongated along a second chamber axis 1207 extending substantially parallel to the first chamber axis 1203 and the elongated opening 1107. Moreover, as shown in FIG. 13, a plurality of apertures 1301a, 1301b, 1301c may provide fluid communication between the first elongated chamber 1201 and the second chamber 1205. Providing separate chambers with the apertures can help facilitate maintenance of a substantially laminar flow fluid film through the elongated opening 1107.

Further referring to back to FIG. 10, the glass treatment apparatus 101 can include a working wheel 1001 configured to rotate in a direction 1104 about a rotation axis 1102 such that an outer peripheral surface 1003 of the working wheel 1001 machines a surface, such as an outer peripheral edge 113, of a glass sheet 111. The glass treatment apparatus can also include a shroud 1005 substantially circumscribing the outer peripheral surface 1003 of the working wheel 1001. In the illustrated example, the shroud 1005 can be open in the Z direction illustrated in FIG. 1 such that gravity may draw fluid, particles and/or other contaminants downward in the Z direction. The shroud 1005 can be designed to shield the pristine surfaces 117, 119 of the glass sheet 111 from particles and/or other contaminants associated with the machining process.

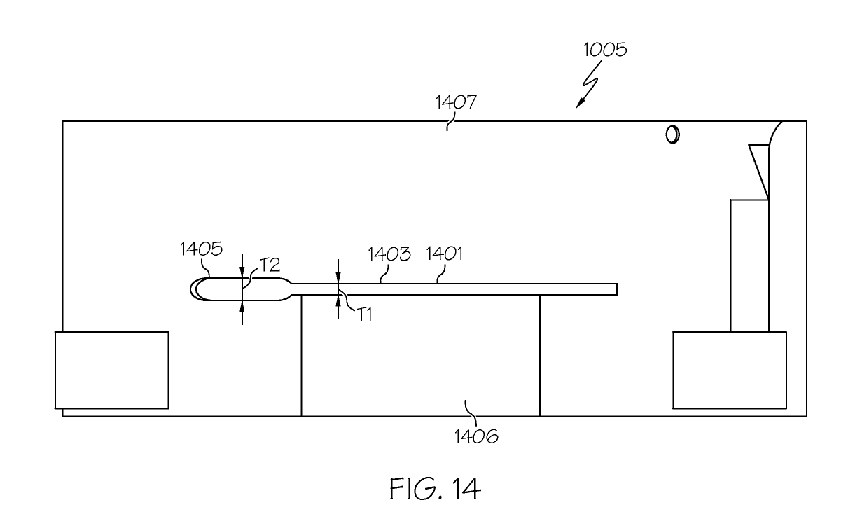

As shown in FIG. 14, if provided, the shroud 1005 can be provided with a slot 1401 configured to receive the edge portion 115 of the glass sheet 111. The slot includes a first segment 1403 having a thickness T1 sufficient to accommodate the edge portion of the glass sheet. The slot 1401 can further include an optional second portion 1405 that may have an enlarged thickness T2 designed to accommodate a fluid nozzle 1007 (see FIGS. 9 and 10) designed to introduce cooling and/or working fluid to the working interface 1015 of the outer peripheral surface 1003 of the working wheel 1001 and the surface of the glass sheet 111. The shroud 1005 may include a recessed inner portion, such as the illustrated planar portion 1406 below the slot 1401 to allow clearance for the fluid film generated by the first and second fluid dispensing devices 901a, 901b

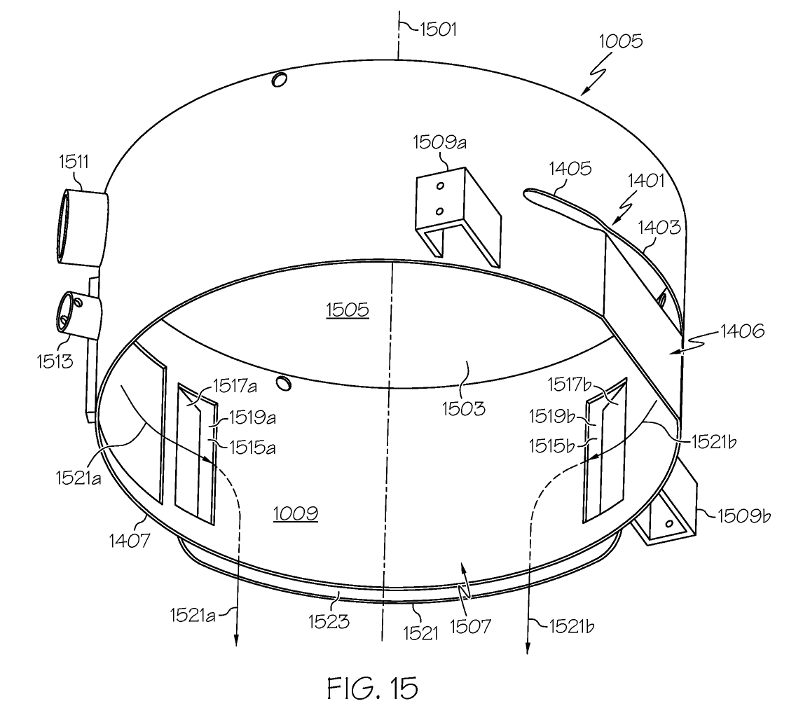

As shown in FIG. 14, the shroud 1005 can include an outer cylindrical peripheral wall 1407. As shown in FIG. 15, in some examples, the outer cylindrical wall 1407 can comprise a circular cylindrical wall disposed about a central axis 1501 of the shroud 1005. As shown in FIG. 10, the shroud 1005 can be mounted relative to the working wheel 1001 such that the central axis 1501 of the shroud 1005 is coincident with the rotation axis 1102 of the working wheel 1001. As shown in FIG. 10, a gap “G” can thereby be maintained between the outer peripheral surface 1003 of the working wheel 1001 and the inner surface 1009 of the shroud 1005. A sufficient gap can be provided to allow movement of fluid along the inner surface 1009 of the outer cylindrical peripheral wall 1407 without substantial interference with the outer peripheral surface 1003 of the working wheel 1101 that may be rotating within a range of 3600-8000 rpm. In one example, the gap “G” may be within a range of from about 5 mm to about 15 mm although the gap may be smaller or larger in further examples.

Turning back to FIG. 15, the shroud 1005 further includes a top wall 1503 with an inner surface 1505 cooperating with the inner surface 1009 of the outer cylindrical peripheral wall 1407 to define a containment area 1507. The containment area 1507 can include an open lower portion and an upper portion that is closed by the top wall 1503. The shroud 1005 can further include one or more brackets 1509a, 1509b configured to provide a mounting location for the fluid dispensing devices 901a, 901b. Still further, the shroud may be provided with a gas port 1511 and or a wheel cleaning port 1513.

As shown in FIG. 10, the gas port 1511 can be provided with a gas nozzle 1017 configured to remove liquid from a portion of the inner surface 1009 of the shroud 1005. The gas port 1511 can therefore provide an air barrier to prevent the liquid from cycling around the inner surface 1009 of the shroud 1005.

As further shown in FIG. 10, the glass treatment apparatus 101 can comprise a fluid source 1011 acting through the wheel cleaning port 1513 and configured to direct a fluid stream 1013 to impact the outer peripheral surface 1003 of the working wheel 1001 to clean the working wheel 1001 from glass particles generated when machining the surface of the glass sheet 111.

As further illustrated in FIG. 15, the outer cylindrical peripheral wall 1407 can be provided with one or more exit ports to allow removal of liquid traveling along the inner surface 1009. For example, as shown in FIG. 15, the shroud includes a first exit port 1515a and a second exit port 1515b formed by bending away corresponding first and second flaps 1517a, 1517b to form corresponding first and second openings 1519a, 1519b, such as the illustrated window openings extending through the outer cylindrical peripheral wall 1407. The first exit port 1515a can allow a stream of fluid traveling along a first direction indicated by arrow 1521a fall down along the first flap 1517a and into the first opening 1519a for subsequent removal from the containment area 1507 of the shroud 1005 as discussed more fully below. Likewise, second exit port 1515b can allow another stream of fluid traveling in an opposite direction indicated by arrow 1521b fall down along the second flap 1517b and into the second opening 1519b for subsequent removal from the containment area 1507 of the shroud 1005 as also discussed more fully below.

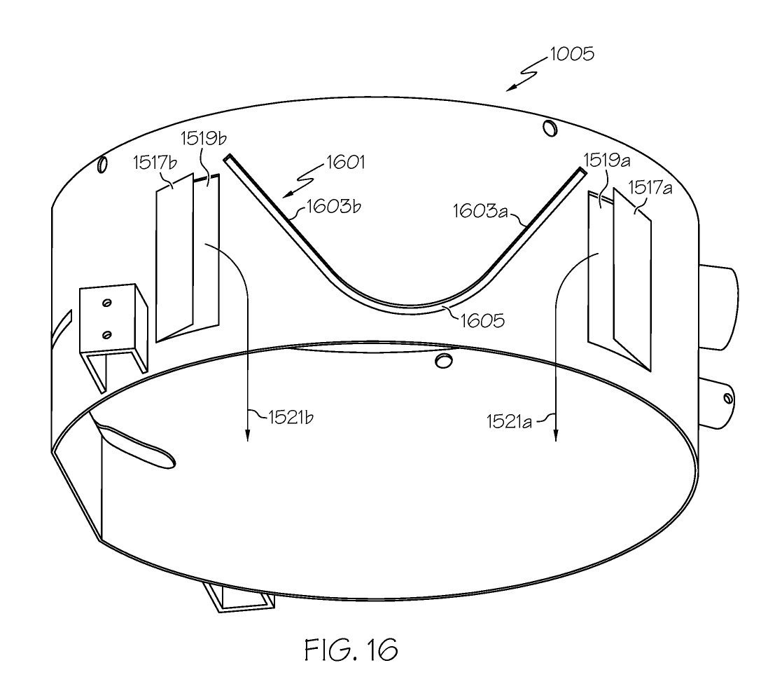

As shown in FIGS. 10 and 15, the shroud 1005 can also include an outer wall portion 1521 configured to facilitate dispensing of liquid and particles exiting the first and second openings 1519a, 1519b to travel down along an outside surface portion of the shroud and out a lower opening 1523 defined between the outer wall portion 1521 and the outer surface portion of the shroud 1005. FIG. 16 illustrates another perspective view of the shroud 1005 with the outer wall portion 1521 removed for clarity. As shown, the shroud 1005 can include a fluid flow guide 1601 that can include a first downwardly inclined guide wall 1603a configured to deflect the fluid exiting the first opening 1519a in a downward direction. Likewise, the fluid flow guide 1601 can include a second downwardly inclined guide wall 1603b configured to deflect the fluid exiting the second opening 1519b in a downward direction. Although not necessary, the guide walls may be connected together by a lower apex portion 1605 to facilitate final exiting of the fluid through the lower opening 1523 and/or to facilitate the manufacturing process.

Turning back to FIG. 1, methods of treating glass can include dispensing the substantially laminar flow 107 of the fluid film 109 along a fluid plane to subsequently land on a first side 117 of a glass sheet 111 as shown in FIG. 4. In one example, the method can include the step of expanding the fluid film 109 with a pair of flow expanders 105a, 105b disposed on each side of the fluid film 109. In such examples, the flow expanders can help expand the fluid film 109 to maintain the laminar flow as the film travels to land on the first surface 117 of the glass sheet 111. Still further, the method can include the step of controlling fluid flow characteristics of the fluid film along the width “W” of the fluid film by controlling the pressure profile across the elongated opening 503 and the velocity profile of the fluid traveling through the elongated opening 503. For example, the pressure profile and/or velocity profile can be controlled by providing at least one of the first elongated chamber 403, the second elongated chamber 407, the apertures 701 and/or the ports 707, 713.

It can also be desired to maintain the laminar flow of the fluid film as the fluid film 109 contacts and thereafter travels along the first side 117 of the glass sheet 111. As shown in FIG. 4, one way of accomplishing a smooth continuous transition is to reduce the angle between the fluid plane and the glass sheet 111. As shown, the fluid dispensing device 103 can be arranged such that an angle “A1” of the fluid plane relative to the planar surface 117 of the glass sheet 111 is within a range of from 0° to about 30°, such as from about 5° to about 30°, such as from about 10° to about 30°.

As shown in FIGS. 9 and 10, methods of treating glass can also include the step of dispensing the substantially laminar flow 903a, 903b of the second fluid film 905a, 905b along a second fluid plane to subsequently contact the second surface 119 of the glass sheet 111. The angle of contact “A2” can be within a range of from 0° to about 30°, such as from about 5° to about 30°, such as from about 10° to about 30°. While other angles can be used in further examples, providing the angle “A1” and/or the angle “A2” within the above-referenced ranges can help maintain an organized fluid flow at the glass-water transition as the fluid film lands on the respective surface of the glass sheet.

Methods of treating the glass can also include machining the edge, such as the outer peripheral edge 113, of the glass sheet 111, wherein machined particles of the glass are entrained in the fluid film and carried away from the glass sheet. For example, as shown in FIG. 10, the working wheel 1001 may be rotated in the direction 1104 about the rotation axis 1102 such that the outer peripheral surface 1003 contacts the edge portion 115 of the glass sheet 111. In one example, the glass sheet 111 can be moved relative to the working wheel 1001 along direction 1019 while the wheel rotates along the clockwise direction 1104 shown in FIG. 10. As such, the working area of the outer peripheral surface 1003 travels in a direction 1021 opposite to the direction 1019 that the glass moves relative to the working wheel 1001. Relative movement between the glass sheet 111 and the glass treatment apparatus 101 can be provided by moving the glass treatment apparatus 101 relative to the glass sheet 111 and/or the glass sheet 111 relative to the glass treatment apparatus 101. The working wheel 1001 can comprise a grinding wheel with diamond particles or other materials sufficient to work (such as grind, polish or otherwise finish) the edge of the glass sheet.

The fluid nozzle 1007 can provide cooling fluid 1008 at the working interface 1015. In one example, the fluid nozzle 1007 extends through an enlarged section 1405 (see FIG. 14) of the slot 1401. The cooling fluid 1008 can then be directed to the working interface 1015 to reduce heat that may otherwise damage the glass sheet 111. The coolant fluid can be directed generally in the direction 1021 of the working portion of the working wheel 1001. Excess cooling fluid 1008 and any particles entrained therein can then be moved away, for example, by the laminar flow of the fluid films 109, 905b from the fluid dispensing devices 103, 901. The cooling fluid 1008 can eventually exit, for example, by passing down through the bottom of the shroud and/or through one of the exit ports in the outer cylindrical peripheral wall 1407.

Particles of glass and/or particles of the grinding wheel may be released during the grinding process. Various example techniques are designed to protect the pristine surfaces 117, 119 of the glass sheet 111 from these particles. As shown in FIGS. 1 and 4, the laminar flow 107 of the fluid film 109 can travel along the first surface 117 in a direction toward the grinding zone. As shown in FIG. 4, the fluid film 109 can freely travel through an upper area of the slot 1401 having a thickness “T3” sufficient to allow uninterrupted passage of the laminar fluid film into the containment area 1507. In one example, “T3” can be about 350 microns although other thicknesses may be used in further examples. Furthermore, the slot clearance underneath the glass sheet may be sufficient, such as similar or identical to T3” for the fluid film 905b. As shown, the overall slot thickness “T1” can be adjusted by an optional shutter 417 depending on the processing parameters of the particular application. In some examples, “T1” may be provided or adjusted to be about 1 mm to about 3 mm although other thicknesses may be used in further examples.

As shown in FIG. 8, a dashed line is shown for illustrative purposes as a line that is parallel to the elongated opening 503 and extends through the fluid plane of the laminar flow 107 of the fluid film 109. The dashed line is also positioned to intersect the edge 113 of the glass sheet 111 at a point where the right side of the fluid film 109, as viewed from the top in FIG. 8, passes over the edge 113 of the glass sheet 111. As such, it will be understood that the laminar flow lines 107 shown in FIG. 8 are perpendicular to both the dashed line and the elongated opening 503 of the fluid dispensing device 103. As represented by the dashed line in FIG. 8, it can be desired to orient the fluid dispensing device 103 such that an angle “A3” of the fluid plane relative to the intersection of the fluid plane and the outer peripheral edge 113 is within a range of about 10° to about 30°, such as about 20°. Providing such an angled orientation can help effectively protect the pristine surfaces of the glass sheet when moving the glass sheet and the glass treatment apparatus relative to one another during a machining procedure.

The laminar fluid film 109 then freely coats the first surface 117 of the glass sheet 111 and travels within and further coats the first surface 117 of the glass sheet 111 in the vicinity of the working area. Particles within the containment area 1507 are thereby prevented from contacting the first surface 117 since any particles that would otherwise land on the first surface 117 are entrained in the fluid film 109 and carried away before the particles have a chance to interact with the first surface 117 of the glass sheet 111. Once entrained, the fluid film then leaves the surface 117 of the glass sheet 111 and can then travel down through the bottom open end of the containment area 1507. Alternatively, the fluid passes along the inner surface 1009 of the outer cylindrical peripheral wall 1407, out the second exit port 1515b and down through the lower opening 1523. As such, the liquid also prevents settling of particles on the inner surface 1009 of the shroud 1005, thereby preventing particle accumulation that may otherwise result in eventual contamination of the pristine surfaces of the glass sheet.

In further examples, another dispensing device, such as the first and/or second fluid dispensing devices 901a, 901b, may be used to help protect the second surface 119 of the glass sheet 111. For example, the fluid film 905a, 905b of the of the fluid dispensing devices 901a, 901b may coat the second surface 119 such that the laminar flow 903a, 903b is maintained as the fluid film travels in a direction substantially parallel to the outer peripheral edge 113 as shown in FIG. 10. Portions of the laminar flow of the fluid film 905b can pass through the slot 1401 and into the containment area 1507. As such, machined particles that may otherwise contact the second surface 119 are entrained into the fluid film 905b and carried away from the glass sheet without damaging the second surface 119 of the glass sheet 111. In one example, the fluid may travel off the glass sheet and down through the bottom open end of the containment area 1507. Alternatively, the fluid can pass along the inner surface 1009 of the outer cylindrical peripheral wall 1407, out the second exit port 1515b and down through the lower opening 1523. Further, if any fluid passes back out through the slot 1401, another laminar flow of film from the second fluid dispensing device 901a can further facilitate removal of the fluid from the lower surface of the glass sheet.

As shown in FIG. 10, methods of the disclosure can include the steps of providing the working wheel 1001 with the outer peripheral surface 1003 and the shroud 1005 substantially circumscribing the outer peripheral surface 1003. The method includes the step of rotating the working wheel 1001 in the direction 1104 about the rotation axis 1102 and moving the glass sheet 111 relative to the glass treatment apparatus 101 such that the edge portion 115 of the glass sheet 111 passes through the slot 1401 with the outer peripheral edge 113 of the glass sheet 111 being machined by the rotating working wheel 1001. The method further includes the step of passing fluid over an inner surface 1009 of the shroud 1005 to carry away machined particles from the glass sheet 111 generated when machining the outer peripheral edge 113 of the glass sheet 111.

In one example, fluid from one of the fluid dispensing devices 103, 901 may eventually pass over the inner surface 1009 of the shroud 1005 and thereafter carry away machined particles. As such, fluid from the fluid dispensing devices 103, 901 passing through the slot 1401 may eventually coat a portion of the inner surface 1009 to prevent particles from accumulating on the inner surface. Rather, any such particles would encounter the fluid passing over the inner surface and eventually pass down through the open bottom of the containment area 1507 and/or through the lower opening 1523.

Therefore, in one example, the method can include the step of dispensing the substantially laminar flow 107 of the fluid film 109 along a fluid plane to subsequently land on the first side 117 of a glass sheet 111 at a location outside of the shroud 1005. The method can then include the step of passing the fluid film 109 along the first side 117 of the glass sheet 111 and through the slot 1401 of the shroud 1005 as shown in FIG. 4. Machined particles of glass can then be entrained in the fluid film before or after a portion of the fluid film passes over the inner surface of the shroud to carry away machined particles from the glass sheet. In one example, the method can further include the step of passing the fluid with the entrained machined particles of glass through one of the exit ports 1515a, 1515b in the shroud 1005.

In another example, the method can include the step of dispensing the substantially laminar flow 903b of the fluid film 905b along a fluid plane to subsequently land on the second side 119 of the glass sheet 111 at a location outside of the shroud 1005. The method can then include the step of passing the fluid film 905b along the second side 119 of the glass sheet 111 and through the slot 1401 of the shroud 1005 as shown in FIGS. 4 and 10. Machined particles of glass can then be entrained in the fluid film before or after a portion of the fluid film passes over the inner surface of the shroud to carry away machined particles from the glass sheet. In one example, the method can further include the step of passing the fluid with the entrained machined particles of glass through one of the exit ports 1515a, 1515b in the shroud 1005.

Further aspects of the disclosure can include cleaning the working wheel from glass particles generated when machining the edge of the glass sheet. Cleaning the working wheel can help manage glass particle accumulation to reduce the probability of large particle masses being spun off of the wheel that may otherwise contaminate the pristine surfaces of the glass sheet. As shown in FIG. 10, such methods can include the step of impacting the outer peripheral surface 1003 of the working wheel 1001 with a fluid stream 1013 to clean the working wheel 1001 from glass particles generated when machining the edge of the glass sheet.

As shown in FIG. 10, the fluid stream 1013 impacts the outer peripheral surface 1003 of the working wheel 1001 at an acute angle “A4” relative to a first axis 1525 that is perpendicular to a second axis 1527 that is tangent to the point of impact 1529. As shown, the angle “A4” can be a positive value wherein it is tilted in the direction of the rotation of the working wheel 1001 or a negative value where it is tilted in away from the direction of the rotation of the working wheel 1001. In one example, “A4” can be 30° in the positive or negative direction as shown in FIG. 10. Other angles may be provided in further examples. Still further, the fluid stream 1013 may be in the direction of the first axis 1525 in still further examples.

As shown in FIGS. 10 and 15, orienting the stream in the positive 30° orientation can help direct fluid toward the first exit port 1515a associated with the first flap 1517a. As such, fluid including particles therein may be directed to exit the first exit port 1515a and or pass down through the bottom opening of the containment area 1507.

In still further examples, the method can include the step of providing an air barrier with the gas nozzle 1017. As such, a portion of the inner surface 1009 may be designed to be substantially free of flowing fluid. For example, with reference to FIG. 10, the inner surface 1009 clockwise from the gas nozzle 1017 to the fluid nozzle 1007 can be designed to be substantially free of liquid. On the other hand, liquid can be maintained along the inner surface 1009 clockwise from the fluid nozzle 1007 and the fluid source 1011. As such, fluid can be encouraged to be removed by one of the exit ports 1515a, 1515b and be prevented from cycling around the inner peripheral wall for further exposure to additional particles at the machining location.

Various aspects of the disclosure discusses above can facilitate finishing techniques that involve machining glass while maintaining the pristine surfaces of the glass sheet. Aspects of the disclosure address various particle source concerns such as: (1) glass particles generated at the edge of the glass during machining; (2) particles including the grinding and polishing coolant; (3) flying particles in the air; and (4) working wheel particles released during the machining process out such finishing techniques while maintaining the pristine surfaces of the glass sheet.

Certain aspects of the disclosure result in a fluid film, such as a water film that may be introduced by fluid dispensing devices 103, 901 to provide sheet water management on both sides of a glass sheet. The fluid dispensing devices can help maintain the pristine surfaces of the glass sheet by creating an uninterrupted laminar film of water or other fluid to overcome particles sources and particle dynamics from various particle sources. In some examples, the particles may be designed to be removed in less than 2.2 seconds to avoid deposition of the particles on the glass surface. The laminar fluid film (e.g., water film) is designed to provide an uninterrupted laminar fluid film and fluid flow rate to all surface areas of the glass sheet exposed to the various sources of particles.

In the orientation shown in FIG. 1, gravity tends to contribute to biasing particles to engage the upper side of the glass sheet while gravity tends to facilitate removal of particles away from the bottom side of the glass sheet. The fluid dispensing device 103 is designed to provide uninterrupted laminar water film and water flow rate before and after the fluid film lands on the upper surface of the glass sheet. Likewise, the fluid dispensing device 901 also provides uninterrupted laminar water film and water flow rate before and after the fluid film lands on the lower surface of the glass sheet. The uninterrupted laminar water film can help prevent particles from penetrating and/or adhering to the glass surface and can help maintain cleanliness and the pristine surfaces of the glass sheet.

Further aspects of the disclosure provide for a self-cleaning shroud that is effective to contain flying particles and prevents particle accumulation inside the shroud. For example, the shroud can help control flying particles and/or prevent accumulation of working wheel residual particles from accumulating inside the shroud. A water wall can be created within the self-cleaning shroud to flush the surface of the shroud, thereby flushing away particles that may have otherwise caused glass contamination issues. As such, the self-cleaning shroud is not only designed to contain flying particles generated during the machining process, but also timely removes the particles from the vicinity of the glass sheet to avoid accumulation inside the shroud that may otherwise present a contamination source of accumulated particles.

Still further aspects of the disclosure provide for one or more fluid (e.g., water) cleaning jets that are designed to strip particles from the working wheel so that the particles do not accumulate and thereafter redeposit on the glass surface at a later time. The water jets can facilitate stripping particles from the working wheel to prevent flying particles and accumulation of particles within the shroud. In some examples, the wheel cleaning jets can be orientated within a range of from about −30° to about +30° to facilitate maximum stripping of particles from the rotating working wheel. Other angles can be provided in further examples depending on the wheel orientation, the glass edge configuration, etc.

Further aspects of the disclosure provide for a shroud with one or more exit ports in the outer cylindrical peripheral wall designed to help reduce the residence time of the water and entrained particles within the containment area of the shroud.

It will be apparent to those skilled in the art that various modifications and variations can be made without departing from the spirit and scope of the claimed invention.

What is claimed is:

1. A glass treatment apparatus comprising:
a fluid dispensing device including first and second flow expanders and a dispensing surface facing a dispensing direction, wherein the dispensing surface defines an elongated opening including an elongated central portion extending between first and second opposed end portions, wherein the first opposed end portion is provided with the first flow expander extending from the dispensing surface in the dispensing direction and the second opposed end portion is provided with the second flow expander extending from the dispensing surface in the dispensing direction,
wherein the fluid dispensing device is configured to dispense a substantially laminar flow of a fluid film from the elongated opening in the dispensing direction between the first and second flow expanders.

2. The glass treatment apparatus of claim 1, wherein the fluid dispensing device is configured to dispense the laminar fluid film in a direction substantially perpendicular to the dispensing surface.

3. The glass treatment apparatus of claim 1, wherein the fluid dispensing device includes a first elongated chamber having a first chamber axis extending along an elongated axis of the elongated opening, wherein the first elongated chamber is in fluid communication with the elongated opening.

4. The glass treatment apparatus of claim 3, wherein the fluid dispensing device includes a second elongated chamber having a second chamber axis substantially parallel to the first chamber axis, wherein the second elongated chamber is in fluid communication with the first elongated chamber and the first elongated chamber is positioned between the elongated opening and the second elongated chamber.

5. The glass treatment apparatus of claim 4, wherein a plurality of apertures provide fluid communication between the first elongated chamber and the second elongated chamber.

6. A glass treatment apparatus comprising:
a fluid dispensing device including a dispensing surface facing a dispensing direction, wherein the dispensing surface defines an elongated opening, the fluid dispensing device further including a first elongated chamber in fluid communication with the elongated opening and including a first chamber axis extending substantially parallel to the elongated opening, the fluid dispensing device further including a second chamber in fluid communication with the first elongated chamber,
wherein the fluid dispensing device is configured to dispense a substantially laminar flow of a fluid film from the elongated opening in the dispensing direction.

7. The glass treatment apparatus of claim 6, wherein the second chamber is elongated along a second chamber axis extending substantially parallel to the first chamber axis and the elongated opening.

8. The glass treatment apparatus of claim 6, wherein a plurality of apertures provides fluid communication between the first elongated chamber and the second chamber.

9. A glass treatment apparatus comprising:
a working wheel configured to rotate such that an outer peripheral surface of the working wheel machines a surface of a glass sheet; and
a shroud substantially circumscribing the outer peripheral surface of the working wheel, wherein the shroud includes a slot configured to receive an edge portion of the glass sheet.

10. The glass treatment apparatus of claim 9, wherein the shroud is provided with a gas nozzle configured to remove liquid from an inner surface of the shroud.

11. The glass treatment apparatus of claim 9, further comprising a fluid source configured to direct a fluid stream to impact the outer peripheral surface of the working wheel to clean the working wheel from glass particles generated when machining the surface of the glass sheet.

12. The glass treatment apparatus of claim 9, further including a fluid dispensing device configured to direct a laminar fluid film along a surface of the glass sheet and into the slot of the shroud.

13. The glass treatment apparatus of claim 12, further comprising another fluid dispensing device configured to direct fluid along another surface of the glass sheet and along the slot of the shroud.

14. The glass treatment apparatus of claim 12, wherein the fluid dispensing device comprises first and second flow expanders and a dispensing surface facing a dispensing direction, wherein the dispensing surface defines an elongated opening including an elongated central portion extending between first and second opposed end portions, wherein the first opposed end portion is provided with the first flow expander extending from the dispensing surface in the dispensing direction and the second opposed end portion is provided with the second flow expander extending from the dispensing surface in the dispensing direction,
wherein the fluid dispensing device is configured to dispense a substantially laminar flow of a fluid film from the elongated opening in the dispensing direction between the first and second flow expanders.

15. The glass treatment apparatus of claim 12, wherein the fluid dispensing device comprises a dispensing surface facing a dispensing direction, wherein the dispensing surface defines an elongated opening, the fluid dispensing device further including a first elongated chamber in fluid communication with the elongated opening and including a first chamber axis extending substantially parallel to the elongated opening, the fluid dispensing device further including a second chamber in fluid communication with the first elongated chamber,
wherein the fluid dispensing device is configured to dispense a substantially laminar flow of a fluid film from the elongated opening in the dispensing direction.

16. A method of treating glass comprising the steps of:
dispensing a substantially laminar flow of a fluid film along a fluid plane to subsequently land on a first side of a glass sheet; and
machining an edge of the glass sheet, wherein machined particles of glass are entrained in the fluid film and carried away from the glass sheet.

17. The method of claim 16, wherein the fluid plane extends at an angle of from about 5° to about 30° from a planar surface of the glass sheet.

18. The method of claim 17, wherein the fluid plane intersects the edge of the glass sheet at an angle of from about 10° to about 30°.

19. The method of claim 16, further comprising the step of dispensing a substantially laminar flow of a second fluid film along a second fluid plane to subsequently land on a second side of the glass sheet, wherein the machined particles of glass are entrained in the second fluid film and carried away from the glass sheet.

20. The method of claim 16, further comprising the step of expanding the fluid film with a pair of flow expanders disposed on each side of the fluid film.

21. A method of treating glass comprising the steps of:
providing a glass sheet;
providing a working wheel with an outer peripheral surface and a shroud substantially circumscribing the outer peripheral surface, wherein the shroud includes a slot;
rotating the working wheel about a rotation axis;
moving the glass sheet and working wheel relative to each other such that an edge portion of the glass sheet passes through the slot with an edge of the glass sheet being machined by the rotating working wheel; and
passing a fluid over an inner surface of the shroud to carry away machined particles from the glass sheet generated when machining the edge of the glass sheet.

22. The method of claim 21, further including the step of passing the fluid with the machined particles of glass through an exit port in the shroud.

23. The method of claim 21, further comprising the steps of:
dispensing a substantially laminar flow of a fluid film along a fluid plane to subsequently land on a first side of a glass sheet at a location outside of the shroud;
passing the fluid film along the first side of the glass sheet and through the slot of the shroud; and then
entraining machined particles of glass in the fluid film inside of the shroud.

24. The method of claim 23, further including the step of passing the fluid with the entrained machined particles of glass through an exit port in the shroud.

25. The method of claim 24, further comprising the step of dispensing a substantially laminar flow of a second fluid film along a second fluid plane to subsequently land on a second side of the glass sheet, wherein the machined particles of glass are entrained in the second fluid film and carried away from the glass sheet.

26. The method of claim 21, further comprising the step of impacting the outer peripheral surface of the working wheel with a fluid stream to clean the working wheel from glass particles generated when machining the edge of the glass sheet.

27. The method of claim 26, further comprising the step of passing the fluid with the glass particles from the working wheel through an exit port in the shroud.

28. A method of treating glass comprising the steps of:
providing a glass sheet;
providing a working wheel with an outer peripheral surface and a shroud substantially circumscribing the outer peripheral surface, wherein the shroud includes a slot;
rotating the working wheel about a rotation axis;
moving the glass sheet and the working wheel relative to each other such that an edge portion of the glass sheet passes through the slot with an edge of the glass sheet being machined by the rotating working wheel; and
impacting the outer peripheral surface of the working wheel with a fluid stream to clean the working wheel from glass particles generated when machining the edge of the glass sheet.

29. The method of claim 28, wherein the fluid stream impacts the outer peripheral surface of the working wheel at an acute angle relative to a first axis that is perpendicular to a second axis that is tangent to the point of impact.

30. The method of claim 29, wherein the angle is about 30°.

31. The method of claim 28, further including the step of passing the fluid with the glass particles from the working wheel through an exit port in the shroud.
